(19) United States
(12) Patent Application Publication
(10) Pub. No.: US 2018/0211326 A1
(43) Pub. Date: Jul. 26, 2018

(54) A METHOD AND SYSTEM FOR TAILORING A PRODUCT BASED ON USER INTERACTIONS

(71) Applicant: COVER GENIUS LIMITED, London (GB)

(72) Inventors: Christopher BAYLEY, Manly NSW (AU); Scott BARNETT, Wollstonecraft NSW (AU); Kailash BALLU, Burwood NSW (AU)

(21) Appl. No.: 15/744,654

(22) PCT Filed: Jul. 15, 2016
(86) PCT No.: PCT/AU2016/050627

§ 371 Date: Jan. 12, 2018

(30) Foreign Application Priority Data
Jul. 15, 2015 (AU) 2015902804

(51) Int. Cl. G06Q 40/08; G06Q 30/06; G06F 17/30

(52) U.S. Cl. CPC G06Q 40/08; G06F 17/30867; G06Q 30/0621

(57) ABSTRACT

Disclosed herein are a method and system for generating tailored content based on user interactions and transactions. The method captures data relating to at least one of an interaction or transaction by the user in relation to a website and stores the captured data in a storage device. The method then generates a set of customer attributes for the user, based on the captured data. On receiving a request for a quotation from the user, the method delivers a product to the user in response to the request, wherein the product is tailored based on the set of customer attributes.

### CROSS-REFERENCE TO RELATED APPLICATIONS

The present application is a national phase entry under 35 U.S.C. § 371 of International Application No. PCT/AU2016/050627, filed 15 Jul. 2016, which claims the benefit of Australian Provisional Patent Application No. 2015902804, titled “A method and system for tailoring a product based on user interactions” and filed on 15 Jul. 2015. The entire contents of each of the foregoing patent applications are hereby incorporated by reference.

### BACKGROUND OF THE INVENTION

### 1. Field of the Invention

The present disclosure relates to a method and system for tailoring content based on user interactions and, in particular, to a method and system for dynamically generating tailored content relating to a product, such as an insurance policy including a schedule of benefits and associated premium pricing, based on customer interactions and transactions.

### 2. Background and Relevant Art

Insurance policies are offered by insurance underwriters in relation to many different products, including houses, cars, boats, health, and business. Such policies are typically offered to consumers via insurance brokers, who interact with both the underwriter and the consumer.

An insurance policy typically includes a schedule of benefits, which defines the terms and conditions under which the insurance policy has effect, the circumstances under which the insurance underwriter will make a payment to the policy holder, and the value or limit of any such payment. An insurance policy also has an associated price or premium, which is the amount payable by the policy holder to maintain insurance coverage. Such a premium may be a single payment or a periodic payment, typically paid on a monthly or annual basis.

The schedule of benefits and premiums associated with an insurance policy are typically determined based on a statistical analysis of a predefined population of users, wherein the analysis measures a likelihood of risk associated with the product to be insured, along with the claims history of that population. However, such policies do not account for the requirements and conditions of individual users.

Individuals have different aversions to risk and different spending habits and capacities. If an insurance company is unable to gather information on such characteristics or traits associated with individuals, then sales opportunities will be lost as a result of not providing a suitable policy in relation to the terms and conditions offered by the policy or the pricing associated with the policy or a combination thereof.

Thus, a need exists to provide an improved method and system for tailoring content based on user interactions.

### SUMMARY

The present disclosure relates to a method and system for generating tailored content in relation to one or more user interactions and transactions. In particular, the method and system gather information in relation to user interactions and transactions and use that information to deliver tailored content to a user.

In a first aspect, the present disclosure provides a method for delivering a tailored product to a user, comprising the steps of:

capturing data relating to at least one of an interaction or transaction by said user in relation to a website, the data including metadata relating to at least one of the interaction or the transaction;

storing said captured data in a storage device;

generating a set of customer attributes for said user, based on said captured data;

receiving a request for a quotation from said user; and

delivering a product to said user in response to said request, said product being tailored based on said set of customer attributes.

In one embodiment, the method further comprises generating a set of customer scores, derived from said set of customer attributes, wherein said product is tailored based on said set of customer scores.

In a second aspect, the present disclosure provides a system for delivering a tailored product to a user, said system comprising:

a server coupled to a communications network, said server including:
a memory for storing data and a computer program;
a processor coupled to said memory for executing said computer program stored in said memory;

a tailoring application forming part of said computer program, said tailoring application including instructions for performing the method steps of:
capturing data relating to at least one of an interaction or transaction by said user in relation to a website, the data including metadata relating to at least one of the interaction or the transaction;
storing said captured data in said memory;
generating a set of customer attributes for said user, based on said captured data;
receiving a request for a quotation from a computing device accessed by said user, said computing device being coupled to said communications network; and
delivering a product to said user in response to said request, said product being tailored based on said set of customer attributes.

In one embodiment, the tailoring application further comprises instructions for generating a set of customer scores, derived from said set of customer attributes, wherein said product is tailored based on said set of customer scores.

In a third aspect, the present disclosure provides a computer readable storage medium having recorded thereon a computer program for delivering a tailored product to a user, said computer program comprising code for performing the steps of:

capturing data relating to at least one of an interaction or transaction by said user in relation to a website;

storing said captured data in a storage device;

generating a set of customer attributes for said customer, based on said captured data;

receiving a request for a quotation from said user; and

delivering a product to said user in response to said request, said product being tailored based on said set of customer scores.

In one embodiment, the program further comprises codes for generating a set of customer scores, derived from said set of customer attributes, wherein said product is tailored based on said set of customer scores.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a flow diagram illustrating a method of delivering tailored content to a user, in accordance with the present disclosure;

FIG. 2 is a schematic representation of a system on which one or more embodiments of the present disclosure may be practised;

FIG. 3 is a schematic block diagram representation of a system that includes a general purpose computer on which one or more embodiments of the present disclosure may be practised;

FIG. 4 is a schematic block diagram representation of a system that includes a general smartphone on which one or more embodiments of the present disclosure may be practised;

FIG. 5 is a schematic block diagram representation illustrating flow of information in the system of FIG. 2;

FIG. 6A is a schematic block diagram representation illustrating generation of data records relating to interactions and transactions;

FIG. 6B is a schematic block diagram representation illustrating content of a data record;

FIG. 7 is a flow diagram illustrating a method for matching collected data with stored data;

FIG. 8 is a schematic representation illustrating grouping of data in a network storage device;

FIG. 9 is a schematic representation of functional modules of an analytic engine;

FIG. 10 is a schematic representation of a method for performing cohort analysis;

FIG. 11 is a flow diagram illustrating a method for calculating customer score values for a non-anonymous customer with a transaction history;

FIG. 12 is a flow diagram illustrating a method for calculating customer score values for a non-anonymous customer without a transaction history;

FIG. 13 is a flow diagram illustrating a method for calculating customer score values for an anonymous customer;

FIG. 14 is a flow diagram illustrating a method for showing a customer a dynamic price and schedule of benefits;

FIG. 15 is a flow diagram illustrating steps performed by the Feature Analysis stage of the analytic engine of FIG. 5;

FIG. 16 is a flow diagram illustrating core steps involved in the Pricing Engine;

FIG. 17 is a flow diagram illustrating a process for applying a pricing strategy to each cohort based on attributes;

FIG. 18 is a flow diagram illustrating a process of optimising the price for attributes that have been assigned a discount pricing strategy;

FIG. 19 is a flow diagram illustrating a process for optimising the increase pricing strategy; and

FIG. 20 is a flow diagram illustrating an overview of a dynamic pricing process.

### DETAILED DESCRIPTION

Method steps or features in the accompanying drawings that have the same reference numerals are to be considered to have the same function(s) or operation(s), unless the contrary intention is expressed or implied.

The present disclosure provides a method and system for generating tailored content in relation to one or more user interactions and transactions. In particular, the method and system gather information in relation to user interactions and transactions and use that information to deliver tailored content to a user.

In the context of this specification, an interaction is any action performed by a user, or an event that occurs in response to such action, in relation to searching, browsing, and acquiring a product and a transaction is a payment relating to the product. Accordingly, an interaction may include, for example, inputs received in a web browser window, movements of a computer mouse including clicks, scrolling, and hovering, completion of online templates, search terms, keywords, and navigation of a website, hyperlinks, and the like. An interaction may also include the event of a web page being displayed to a user for more than 30 seconds or some other predefined time period.

In one arrangement, the method and system capture user interactions and transactions conducted using a computing device, such as a personal computer, smartphone, tablet device, or the like, and store the associated information as data records in a database. The database may be implemented as a networked storage device, such as an array of one or more hard disk drives. The data records include event data provided by the user and metadata captured relating to the interactions and transactions performed by the user. The method and system store the data records with tags identifying the interactions and transactions.

The method analyses the stored data records, based on the associated tags, in order to generate various customer attributes for each user, based on customer behaviour and transaction history. The method uses the customer attributes associated with a customer to tailor content to be delivered to that particular customer. In one implementation, the method further generates customer scores, derived from said customer attributes. In such an implementation, the method optionally tailors content to be delivered to the particular customer based on the customer scores, alone or in combination with one or more of the other customer attributes.

In one arrangement, a customer requests a quotation for a car rental insurance policy and the method generates an insurance policy that includes a schedule of benefits and a policy premium. In such an arrangement, cohort analysis is performed on stored data records to generate the schedule of benefits and the policy premium is based on customer scores associated with that customer. The customer scores are optionally determined using different algorithms, based on whether the customer is anonymous, non-anonymous with a transaction history, or non-anonymous without a transaction history.

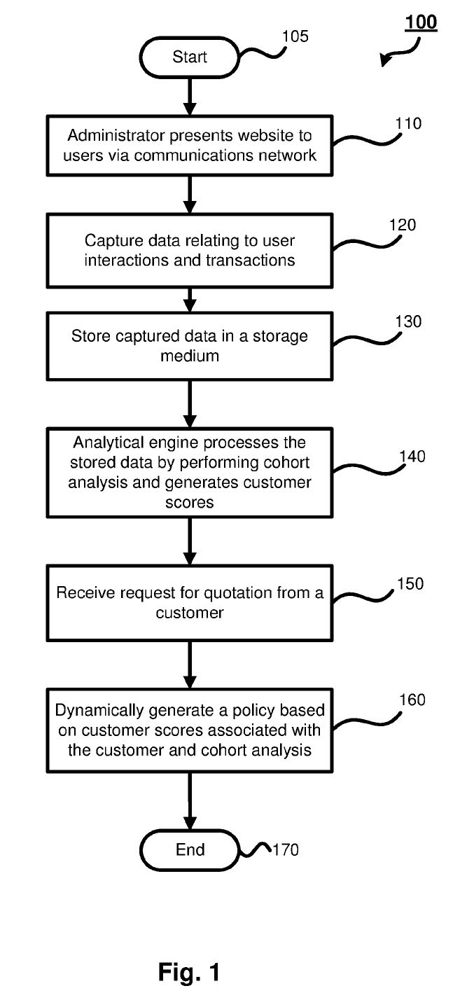

FIG. 1 is a flow diagram illustrating a method 100 for generating tailored content in relation to one or more user interactions and transactions. In the example of FIG. 1, the tailored content will be described with reference to car rental insurance policies offered by an administrator of a car rental insurance website. The method 100 begins at a Start step 105 and proceeds to step 110, in which the administrator presents a website hosted by a web server to users via a communications network. The communications network may be implemented using a Wide Area Network (WAN), such as the Internet, with each of the components of the system addressable using a network or Internet Protocol (IP) address.

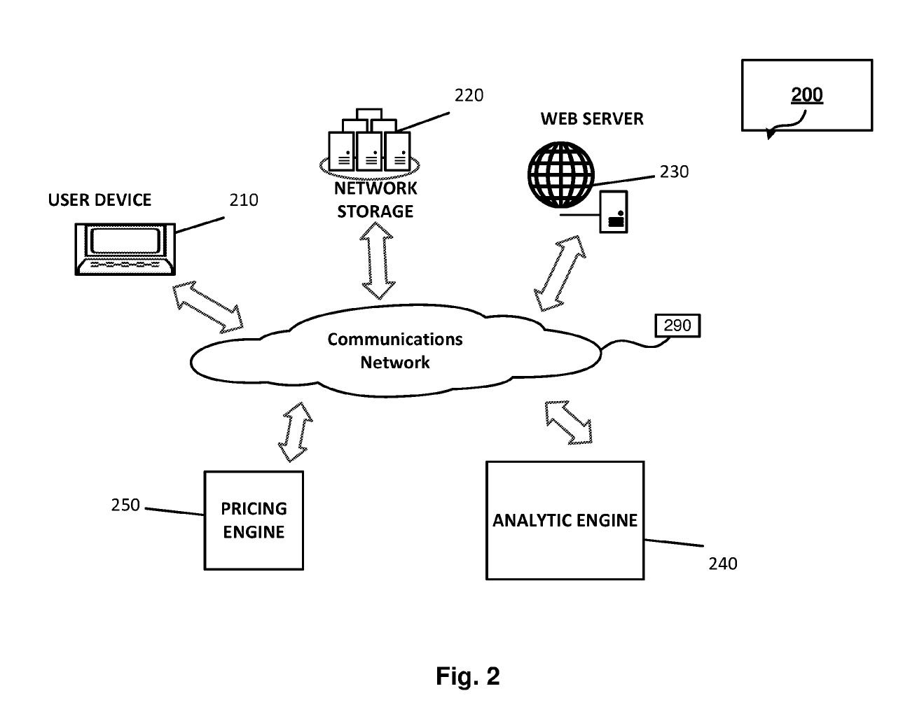

FIG. 2 is a schematic representation of a system 200 on which the method 100 can be practised. The system 200 includes a web server 230 for hosting the car rental insurance website. The web server 230 is coupled to a communications network 290, which may be implemented using a WAN, such as the Internet. The system 200 also includes a user computing device 210 that a user can use to interact with the website hosted by the web server 230. The system 200 further includes a network storage device 220, an analytic engine 240, and a pricing engine 250, each of which is coupled to the communications network 290.

Returning to FIG. 1, step 120 captures data relating to user interactions and transactions performed using the website. The user interaction with the website typically follows that used by other ecommerce sites. A user uses the computing device 210 coupled to the communications network 290 to interrogate a server/service 230 connected to the network 290 via an address or a Universal Resource Locator (URL). For example, the user uses a browser executing on a processor of the computing device 210 to access a URL associated with the website presented by the administrator and hosted on the web server 230.

The web server 230 serves content to a browser window displayed on the computing device 210 accessed by the user. Content, typically in the form of HTML, CSS and JavaScript (ECMAScript) code, serves text, images, and links for navigating services offered through the website. In one arrangement, JavaScript is embedded within an application and forms part of the response from the web server 230. The website is able to relay information to and obtain information from the user to facilitate navigation by the user through the various states or stages of the interaction. Such states or stages may include, for example, obtaining product information, customising the product to suit the needs of the user, requesting a quotation for the customised product, and making a payment for the product and tracking delivery of the product to a delivery address.

The method of the present disclosure captures user interactions and transactions performed using the computing device 210. In one implementation, the computing device 210 displays a browser window on a display of the computing device 210 and code associated with the website, such as a JavaScript plugin or the like, captures user interactions and transactions. Such user interactions may include inputs presented via an input device, as well as mouse movements or other inputs, such as touchscreen swipes and clicks. In an alternative embodiment, a processor on the computing device 210 executes a software application (“app”) associated with the website, wherein the app includes code for capturing interaction and transaction data.

Returning to FIG. 1, control passes from step 120 to step 130, in which interaction and transaction data are tagged and transmitted from the computing device 210 accessed by the user for storage on the network storage device 220, which may be integral with or external to the web server. In step 140, the analytic engine 240 accesses and analyses the stored data. Depending on the particular application, the website may capture many user interactions and transactions over long periods of time and relating to any number of users. The analytic engine 240 does a customer-wise cohort analysis and allocates customer scores to each customer, based on customer behaviour, transaction history, and attributes. The analytic engine 240 produces multiple cohorts using different attributes that describe different customer segments.

In step 150, a customer uses a computing device 210 to interact with the website to obtain a quotation for an insurance policy. In step 160, a pricing engine 250 associated with the web server 230 uses the customer scores and cohorts determined by the analytic engine 240 for that particular customer to generate dynamically tailored content for the customer in the form of a tailored schedule of benefits and premium. The tailored content is then sent to the customer, either for display on the computing device 210 or by email, traditional mail, or other means. Control passes from step 160 to step 170 and the method 100 terminates.

The user device 210 may be implemented using any computing device that is connected to a communications network, such as the Internet, and allows user interaction with the ability to render HTML and JavaScript. One example of the user device is a Personal Computer (PC) that is connected to the Internet and is able to run a web browser. One other example of a user device is a mobile phone or tablet device that is able to request information from the web server 230 through web API calls, and render HTML and JavaScript code using a native application.

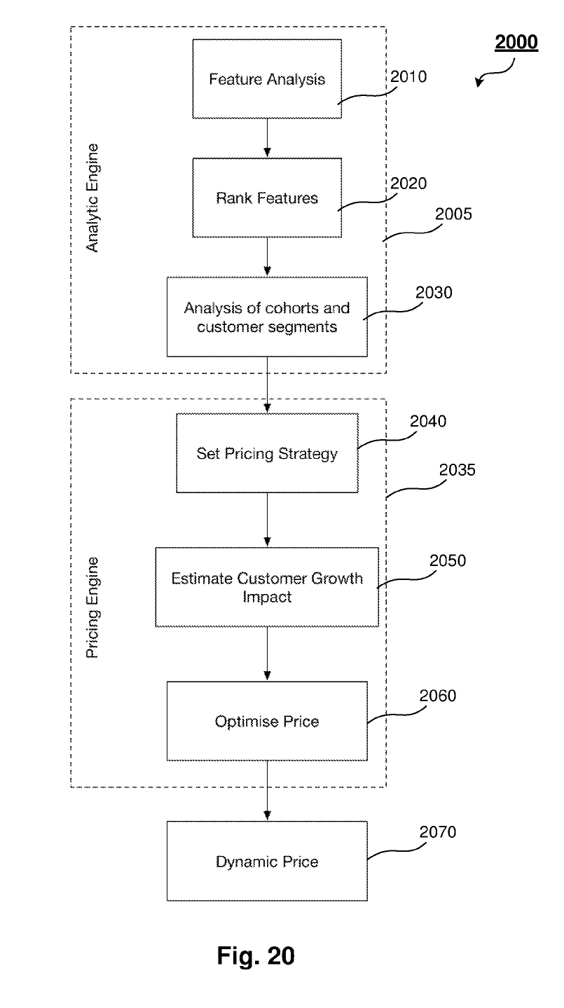

FIG. 20 is a flow diagram illustrating an overview of a dynamic pricing method 2000. An Analytic Engine 2005 includes a Feature Analysis step 2010, Rank Features step 2020, and an Analysis of cohorts and customer segments step 2030. The Feature Analysis step 2010 feeds into the Rank Features step 2020, which, in turn, feeds into the Analysis of cohorts and customer segments step 2030.

The output of the Analytic Engine 2005 is presented to a Pricing Engine 2035, which includes a Set Pricing Strategy step 2040, an Estimate Customer Growth Impact step 2050, and an Optimise Price step 2060. The output of the Optimise Price step 2060 is presented as the output of the Pricing Engine to a Dynamic Price step 2070.

The first phase of the dynamic pricing process is performed by the Analytic Engine 2005. First, the Feature Analysis stage is performed in step 2010 to identify important features. Next, control passes to step 2020, where each feature is ranked for the impact that feature will have on price. In step 2030, customer cohort analysis is performed and customer segments are identified. Next, control passes to the Pricing Engine 2035. Then, the pricing strategy is determined for each customer segment and each cohort in step 2040. In one embodiment, this is done by analysing the conversion rate for that particular segment or cohort. In step 2050, the impact of the proposed dynamic pricing is modelled. Next, the price is optimised in step 2060. In one embodiment, the optimisation is done through A/B testing. Finally, the calculated dynamic price is calculated in step 2070.

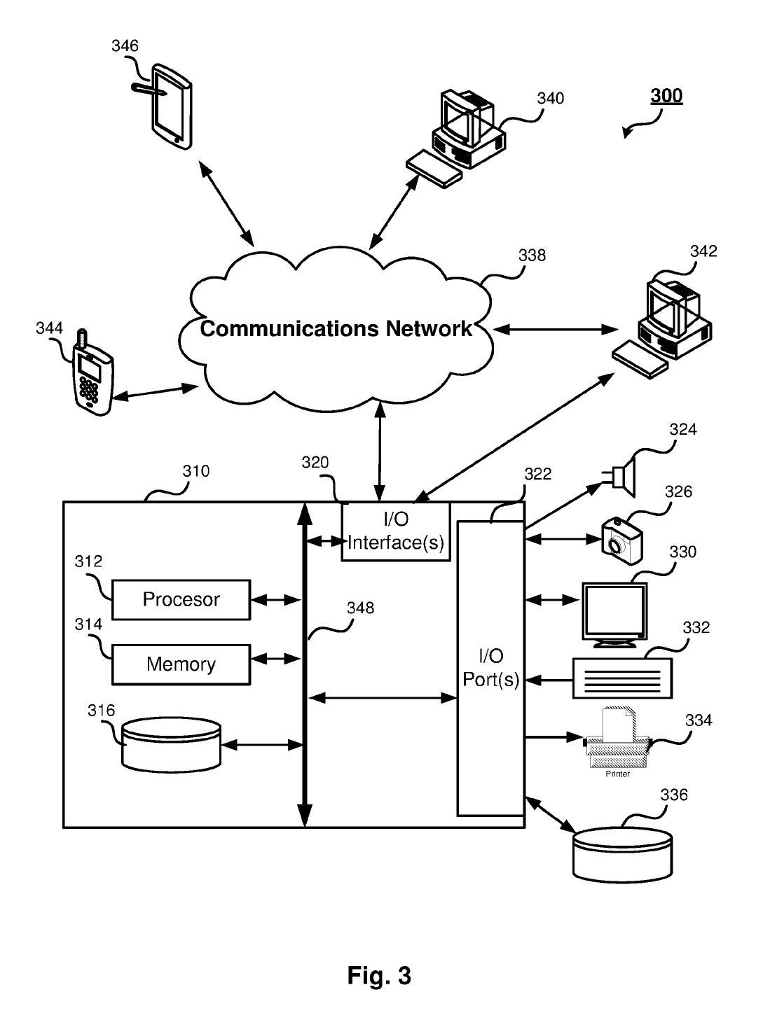

The content tailoring system of the present disclosure may be practised using a computing device, such as a general purpose computer or computer server. FIG. 3 is a schematic block diagram of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a camera 326, a display device 330, an input device 332, a printer 334, and an external storage medium 336. The speaker 324 may be implemented using one or more speakers, such as in a stereo or surround sound system. In the example in which the general purpose computer 310 is utilised to implement the computing device 210, one or more peripheral devices may relate to a mouse or keyboard connected to the I/O ports 322.

The camera 326 may be a webcam, or other still or video digital camera, and may download and upload information to and from the general purpose computer 310 via the I/O ports 322, dependent upon the particular implementation. For example, images recorded by the camera 326 may be uploaded to the storage medium 316 of the general purpose computer 310. Similarly, images stored on the storage medium 316 may be downloaded to a memory or storage medium of the camera 326. The camera 326 may include a lens system, a sensor unit, and a recording medium.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a server acting as a web server 230 to implement a content tailoring method and system in accordance with the present disclosure. In such an embodiment, the memory 314 and storage 316 are utilised to store data relating to user interactions and transactions. Software for implementing the content tailoring system or for providing a browser to view content from the web server 230 is stored in one or both of the memory 314 and storage 316 for execution on the processor 312. The software includes computer program code for implementing method steps in accordance with the method of tailoring content based on user interactions and transactions described herein.

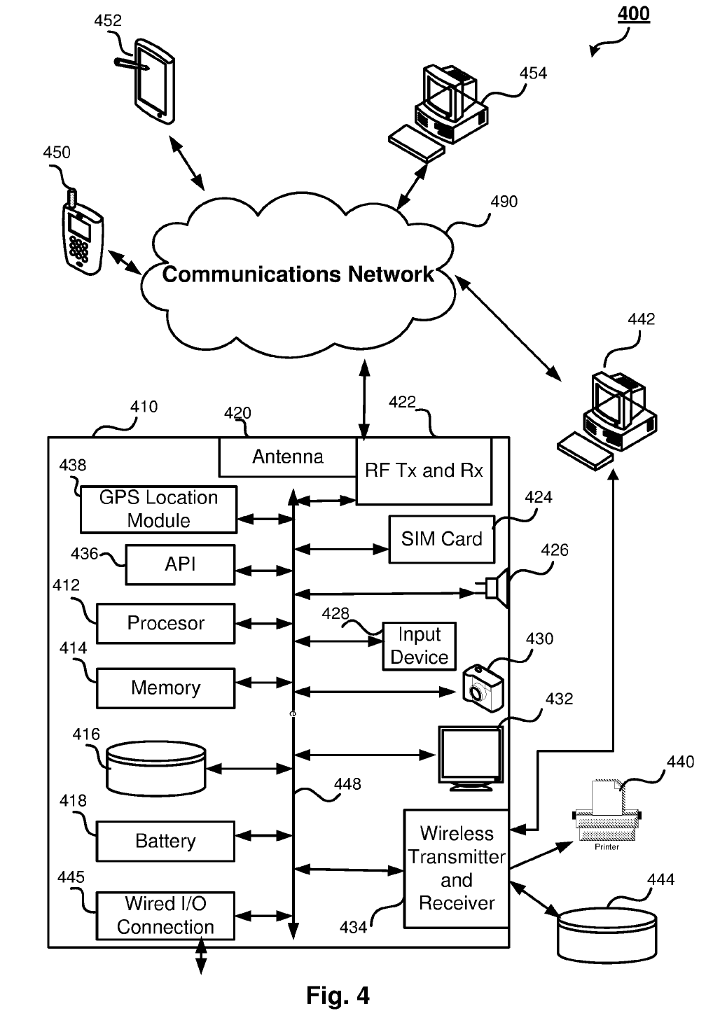

FIG. 4 is a schematic block diagram of a system 400 on which one or more aspects of a content tailoring method and system of the present disclosure may be practised. The system 400 includes a portable computing device in the form of a smartphone 410, which may be used by a customer of the car rental insurance system hosted by the web server 230. The smartphone 410 includes a plurality of components, including: a processor 412, a memory 414, a storage medium 416, a battery 418, an antenna 420, a radio frequency (RF) transmitter and receiver 422, a subscriber identity module (SIM) card 424, a speaker 426, an input device 428, a camera 430, a display 432, and a wireless transmitter and receiver 434. Components of the smartphone 410 generally communicate using one or more bus connections 448 or other connections therebetween. The smartphone 410 also includes a wired connection 445 for coupling to a power outlet to recharge the battery 418 or for connection to a computing device, such as the general purpose computer 310 of FIG. 3. The wired connection 445 may include one or more connectors and may be adapted to enable uploading and downloading of content from and to the memory 414 and SIM card 424.

The smartphone 410 may include many other functional components, such as an audio digital-to-analogue and analogue-to-digital converter and an amplifier, but those components are omitted for the purpose of clarity. However, such components would be readily known and understood by a person skilled in the relevant art.

The memory 414 may include Random Access Memory (RAM), Read Only Memory (ROM), or a combination thereof. The storage medium 416 may be implemented as one or more of a solid state “flash” drive, a removable storage medium, such as a Secure Digital (SD) or microSD card, or other storage means. The storage medium 416 may be utilised to store one or more computer programs, including an operating system, software applications, and data. In one mode of operation, instructions from one or more computer programs stored in the storage medium 416 are loaded into the memory 414 via the bus 448. Instructions loaded into the memory 414 are then made available via the bus 448 or other means for execution by the processor 412 to implement a mode of operation in accordance with the executed instructions.

The smartphone 410 also includes an application programming interface (API) module 436, which enables programmers to write software applications to execute on the processor 412. Such applications include a plurality of instructions that may be pre-installed in the memory 414 or downloaded to the memory 414 from an external source, via the RF transmitter and receiver 422 operating in association with the antenna 420 or via the wired connection 445.

The smartphone 410 further includes a Global Positioning System (GPS) location module 438. The GPS location module 438 is used to determine a geographical position (or geolocation) of the smartphone 410, based on GPS satellites, cellular telephone tower triangulation, or a combination thereof. The determined geographical position may then be made available to one or more programs or applications running on the processor 412.

The wireless transmitter and receiver 434 may be utilised to communicate wirelessly with external peripheral devices via Bluetooth, infrared, or other wireless protocol. In the example of FIG. 4, the smartphone 410 is coupled to each of a printer 440, an external storage medium 444, and a computing device 442. The computing device 442 may be implemented, for example, using the general purpose computer 310 of FIG. 3.

The camera 426 may include one or more still or video digital cameras adapted to capture and record to the memory 414 or the SIM card 424 still images or video images, or a combination thereof. The camera 426 may include a lens system, a sensor unit, and a recording medium. A user of the smartphone 410 may upload the recorded images to another computer device or peripheral device using the wireless transmitter and receiver 434, the RF transmitter and receiver 422, or the wired connection 445.

In one example, the display device 432 is implemented using a liquid crystal display (LCD) screen. The display 432 is used to display content to a user of the smartphone 410. The display 432 may optionally be implemented using a touch screen, such as a capacitive touch screen or resistive touchscreen, to enable a user to provide input to the smartphone 410.

The input device 428 may be a keyboard, a stylus, or microphone, for example, for receiving input from a user. In the case in which the input device 428 is a keyboard, the keyboard may be implemented as an arrangement of physical keys located on the smartphone 610. Alternatively, the keyboard may be a virtual keyboard displayed on the display device 432.

The SIM card 424 is utilised to store an International Mobile Subscriber Identity (IMSI) and a related key used to identify and authenticate the user on a cellular network to which the user has subscribed. The SIM card 424 is generally a removable card that can be used interchangeably on different smartphone or cellular telephone devices. The SIM card 424 can be used to store contacts associated with the user, including names and telephone numbers. The SIM card 424 can also provide storage for pictures and videos. Alternatively, contacts can be stored on the memory 414.

The RF transmitter and receiver 422, in association with the antenna 420, enable the exchange of information between the smartphone 410 and other computing devices via a communications network 490. In the example of FIG. 4, RF transmitter and receiver 422 enable the smartphone 410 to communicate via the communications network 490 with a cellular telephone handset 450, a smartphone or tablet device 452, a computing device 454 and the computing device 442. The computing devices 454 and 442 are shown as personal computers, but each may be equally practised using a smartphone, laptop, or a tablet device.

The communications network 490 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

A customer interacts with a user interface of a web-based or mobile app rendered on the display 330, 432 of the user device using one or more input devices. Through these interactions, the web server 230 orchestrates the user through the various stages of the ecommerce lifecycle. At each stage, the web server 230 collects and relays information to the user through the user device 210. Additionally, interactions may be tracked natively by code on the web and mobile apps. The code may be implemented, for example, using JavaScript. The JavaScript code thus captures the different interactions and transactions by the user on the computing device 210.

An example of an interaction is the user clicking a menu option rendered on the browser of the web app. The JavaScript in the web browser captures this event in real time. The JavaScript code optionally tags event data relating to the interaction and transmits the event data, along with any other relevant metadata for storage at the network storage 220.

The metadata may include, for example, the state of the interaction and user and device information. In one arrangement, the metadata information are broadly grouped in to the following:
User device information such as form factor and operating system;
Browser and browser settings information, such as the browser software, version, etc., and browser setting information, such as flags showing features that have been enabled;
Timestamp, geolocation information, and IP address of the user device; and
Session, device and user identification information using first and third party cookies.

Apart from the metadata that is collected on every request from the computing device 210 to the web server 230, information is contained in the request itself. This information (data) informs the web server 230 as to the kind of content and/or resource that needs to be served or an action that needs to be taken by the web server 230.

The information that can be gleaned from the request data are broadly grouped in to the following:
Requested URL and URL parameters;
Any additional information sent with the URL, such as the referral links to the URL, referred by parameters; and
Data payload with the request.

The data payload varies, depending on the request. For example, when a GET request is made for a particular product, then the payload includes data relating to the product that is being requested. Another example is when a POST request is made, in which case the payload includes fields that have been paid out.

Event tracking scripts, such as JavaScript, track the interactions of the user. Such scripts are capable of capturing every interaction, such as button clicks, mouse hovers and moves, form fills, link clicks, image and video operations, items added to and deleted from a shopping cart, and payments made. Each time an event occurs, the system captures both data and metadata about the event. The data about the event can be grouped as following:
Event information such as the type of event and the data related to the event.

As an example, if the event is the user adding an item to the shopping cart, then the event would be an “add to cart” event and the data would be the product that was added to the cart. This data about the event is specific to the event.

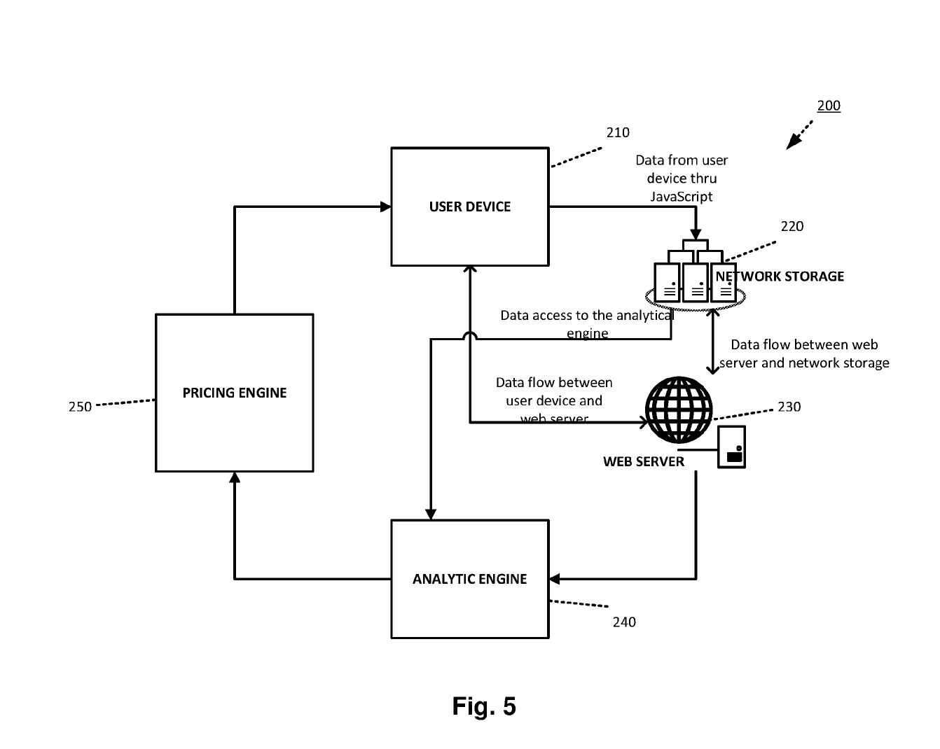

FIG. 5 illustrates the flow of information within the system 200. Data flows between the user computing device 210 and the web server 230. The web server 230 also communicates with the analytic engine 240 and the network storage 220. The analytic engine 240 receives stored data from the network storage 220 and provides analysed data to the pricing engine 250, which in turn provides tailored content, such as an insurance quotation including a schedule of benefits and pricing, to the computing device 210.

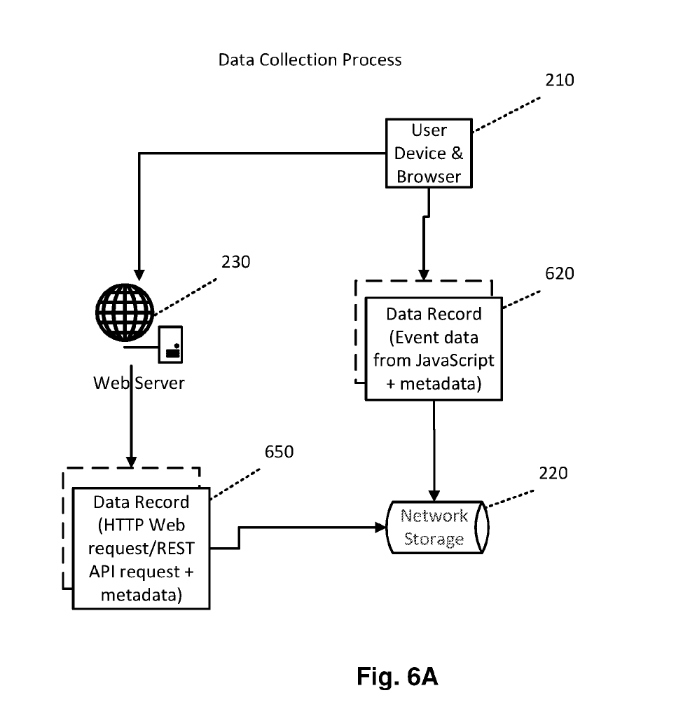

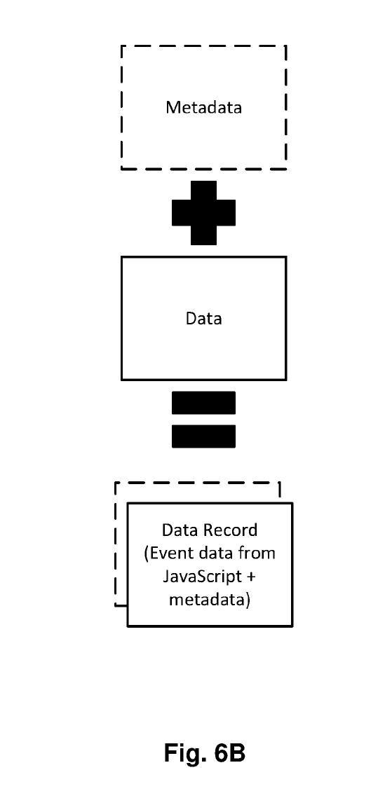

FIG. 6A illustrates the data collection process of steps 120 and 130 of FIG. 1. In one arrangement, the user computing device 210 is a Personal Computer with a web browser capable of rendering HTML and interpreting JavaScript code. The user interacts with the web server 230 over the internet 290 using a URL scheme. The web server 230 is able to orchestrate the user through the various states or stages of interaction, collecting information from the user at each stage, along with device and user data 620, 650. Furthermore, additional event data 650 is collected by the JavaScript code that is served up by the web browser 230 and sent to the network storage 220 attached to the network 290. In the example of FIG. 6A, data 620 is interaction data captured by Javascript executing within the application and sent from the user device 210 directly to the network storage 220.

The web server 230 captures the state of the user interaction and guides the user through various stages of the ecommerce lifecycle. The user obtains content from the web server 230 using various URL links provided by the web server 230 and sends information back to the web server 230 through form submissions or other input forms. A web request is made using an URL. The URL enables the web server 230 to service the request and return appropriate content. The URLs are invoked by a user typing the URL into a web browser executing on a computing device 210 accessed by the user, or the user clicking on a hyperlink displayed on a display device of said computing device 210, or filling in a web form or the like.

At each interaction through the link or at each form submission, the web server 230 captures state information relating to the user, along with information 620, 650 provided by the user. Additionally, the web server 230 optionally obtains metadata information, such as the geolocation of the user, network address of the computing device 210, and information about the computing device 210 and browser used by the user. The web server 230 stores all this information on the network storage 220.

The web server 230 optionally provides authorisation and user authentication services that allow the web server 230 to identify uniquely different users and selectively allow access to some or all of the various resources provided by the web server 230. A user is able to interact with the website hosted by the web server 230 either anonymously or non-anonymously. In one arrangement, anonymous interaction provides a user with a smaller subset of interactions, relative to non-anonymous interaction. The web server 230 collects event data and metadata relating to anonymous interactions, but such interactions do not include user-specific information, as the user has not been formally identified through an authentication process, such as logging in with a username and password.

The web server 230 tracks user interactions across the various states and interactions for both anonymous and non-anonymous users. For non-anonymous users, the web server 230 tracks interactions through the use of unique identifiers allotted to the user on logging in for the first time. For anonymous users, the web server 230 tracks events through use of first party and third party cookies or through the above-mentioned JavaScript code. In case the user computing device 210 does not allow user tracking through cookies or if the user has disabled cookies, data collection is performed by the JavaScript code, which relays state and event data to the network storage 220.

FIG. 6B is a schematic illustration showing that a data record is composed of metadata and data relating to an interaction or transaction. The data is information supplied by the user, such as the content input to a field of a template form. The metadata is information captured by JavaScript code or the browser itself and relates to the state of the computing device 210, user preferences, and the state of the interaction or transaction.

The storage device 220 is a database system capable of storing data captured from the computing device 210 used by the user and is coupled to a communications network 290, such as the Internet. In one implementation, the storage device 220 is integral with the web server 230. In another implementation, the storage device 220 is a separate device. In one arrangement, the data base system 220 stores structured data that can be queried using SQL or NoSQL. In one arrangement, the storage device 220 stores data in a relational database system setup in the cloud and connected to the Internet.

The analytic engine 240 may be implemented using a computer program that is capable of interacting with stored data, both data stored in network storage 220 and data stored in the web server 230, and make statistical calculations. The analytic engine 240 determines key attributes about a customer and scores a customer on several dimensions. In one arrangement, the analytic engine 240 calculates customer scores based on one or more of customer interaction history, claims data, and data stored of other customers to predict customer lifetime value, retention, and churn scores for the particular customer. The analytic engine 240 is able to adapt based on available customer data. This customer data availability can be grouped into three groups, namely: (i) customers with event history; (ii) customers with transaction history; and (iii) customers with very little or no event or transaction history.

The scores and the cohorts are then provided by the analytic engine 240 to the pricing engine 250. The pricing engine 250 may be implemented using a computer program that receives the customer scores as calculated in the analytic engine 240 and provides tailored content to the particular customer in the form of a schedule of benefits and price. The pricing engine 250 is able to dynamically calculate the price and schedule of benefits and feed it back to the customer in real time.

The analytic engine 240 and pricing engine 250 may be integral with the web server 230, integral with each other, or independent modules coupled to the communications network 290.

In the example in which a customer accesses a website to buy car rental insurance, the method includes the following steps:
The customer visits the insurance home page.
The customer searches for an insurance product by entering the duration of insurance needed, the country or jurisdiction for which the insurance is needed, the age of the driver for whom the insurance is needed, and the type of car for which the insurance is needed. This search data is sent from the user computing device 210 to the web server 230.
The web server 230 returns a quotation including policy details and pricing.
The customer might obtain several such quotations by varying the search criteria or, on the other hand, proceed to make a payment to buy the insurance.
Once the customer lands on the payment page, more personal information and credit card details are sought.
On successful payment, the web server 230 confirms and delivers the policy.
Additionally, at any time along the process, the customer can identify himself by logging in as a returning user. In this case, the customer can be matched to personal information in the network storage obtained during earlier web browsing sessions by the customer.

At each process step, data is collected and requests are processed by the web server 230. All the data collected is stored in the network storage 220. This network storage 220 over time will have data relating to a returning user/customer.

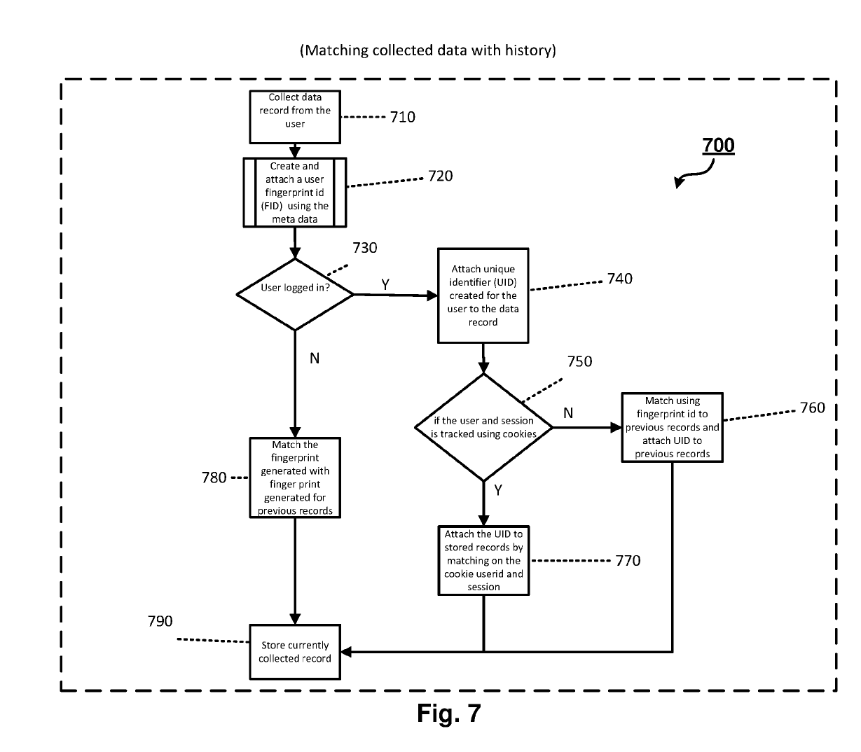

The process for matching a user interaction with previous or historical data is outlined and illustrated with reference to the method 700 of FIG. 7. The method 700 begins with a data collection step 710 corresponding to the data generation process described and illustrated with reference to FIG. 6A. In particular, the data collection step 710 includes generation of the data record 620 produced via a JavaScript code executing in association with the browser and/or the data record 650 produced via the request to the web server 230. The method seeks to match the data record collected in step 710 with historical data stored in the network storage 220.

Control passes from step 710 to step 720, which creates a unique fingerprint identifier (FID) from the data and metadata generated in step 710. Step 730 determines whether the user is logged in, which means the user has previously signed in by providing his personal details. Personal details which are recorded in the network storage 220 include a unique identifier (UID) created for the user. A fingerprint identifier matches user interactions based on metadata captured with the event and web requests. Each event or web request has information about the IP and user device characteristics, geo location, and the like. The metadata information taken as a whole can be used to identify the user. Thus, it is referred to as a fingerprint because it is not based on self-identification by the user, as would occur with the UID, but by other characteristics of the user.

If step 730 determines that the user is logged in, Yes, and thus already has a UID, control passes from step 730 to step 740, which attaches the UID associated with the user to the current data record generated in step 710. Control passes from step 740 to decision step 750, which checks if the user and session information are being tracked using cookies. If the user and session information are being tracked using cookies, Yes, control passes from step 750 to step 770, which matches the user and session information, attached by cookie to the current record, to the cookie information set on previous records. Control then passes to step 790, which stores the currently collected record. If at step 750 the user and session are not being tracked by cookies, No, control passes to step 760, which matches the current record to previous records using the FID generated for the current record in step 720 to an FID generated for the previous records. Once a fingerprint identifier match is obtained, the previous record is updated with new UID.

Returning to step 730, if the user is not logged in, No, control passes to step 780, which matches the FID of the current data record with the FID of the previous records for users who are not logged on. Control then passes to step 790, which stores the current data record the network storage 220.

The process 700 allows for matching a current data record with data relating to previous historical actions of the customer, thus giving an overview of all events and transaction history of a user, irrespective of whether or not the user is accessing the website in an anonymous or non-anonymous manner. Consequently, it is possible to reconstruct the interactions of a customer in a chronological order, from the information available in the stored records associated with the same FID as the customer. Analysing the records of a particular user provides valuable information, such as the number of quotes that a particular customer requested before making or not making a booking.

The analytic engine 240 processes the data in the network storage 220 to assign customer scores to each customer and determine key attributes for cohorts. In one implementation, the analytic engine calculates customer scores every x minutes, where x is determined based on the number of new events being added to the network storage. Every new record added to the network storage not only impacts the scores for that particular customer, but also impacts the scores of other customers as well. For example, in one implementation x is 10. In an alternative arrangement, the analytic engine 240 runs the analysis on stored data records in real-time or near real-time.

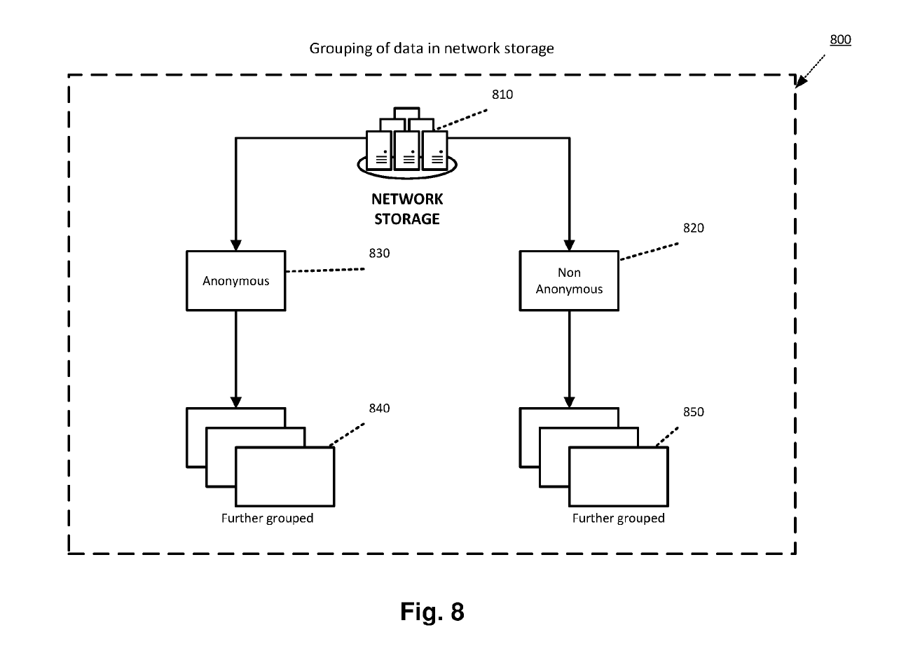

The data stored in the network storage 220 is grouped for analysis. The grouping of the data is illustrated in the method 800 of FIG. 8. As noted above, each data record is stored with a unique identifier. The unique identifier includes an indication of whether or not the user associated with the data record was an anonymous or non-anonymous user. All the records are grouped based on whether the record has a non-anonymous or anonymous customer identifier attached. These groups are referred to as non-anonymous and anonymous groups 820, 830, respectively. The data is further grouped for analysis along other dimensions or attributes of the records 840 and 850. In one arrangement, the records are further grouped based on the country of the user device, as ascertained by the geolocation. This grouping is referred to as country grouping. In another arrangement, the records are further grouped based on the continent of the user device.

Anonymous data records will never include a payment transaction, since a customer will have had to give out personal information in order to purchase a policy or transact on the system. On the other hand, non-anonymous records will have both kinds of customers, that is, customers with and without payment transactions.

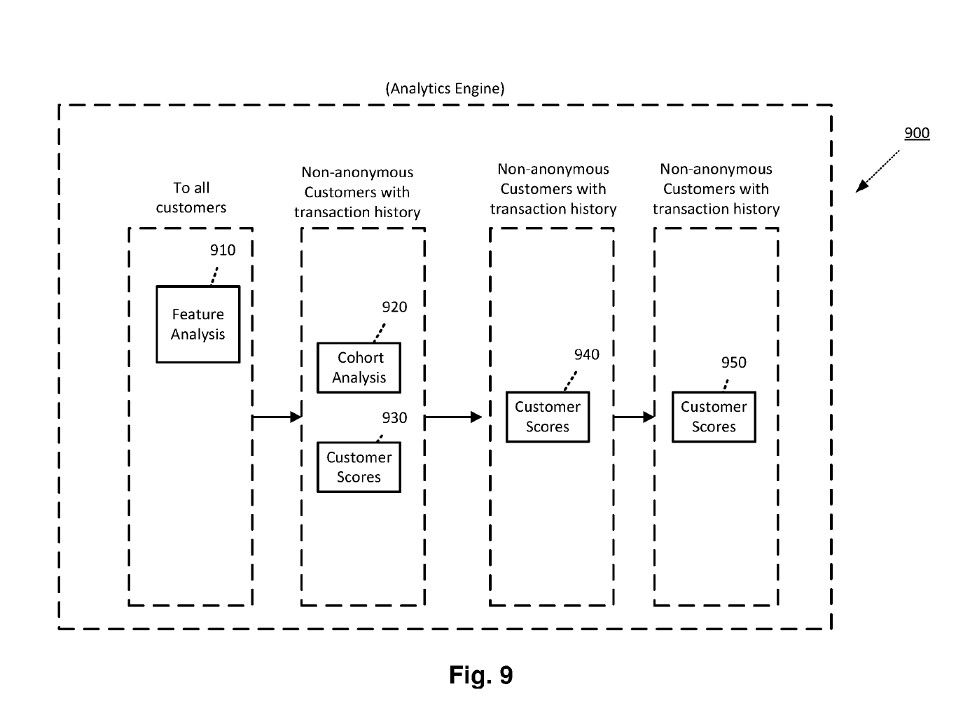

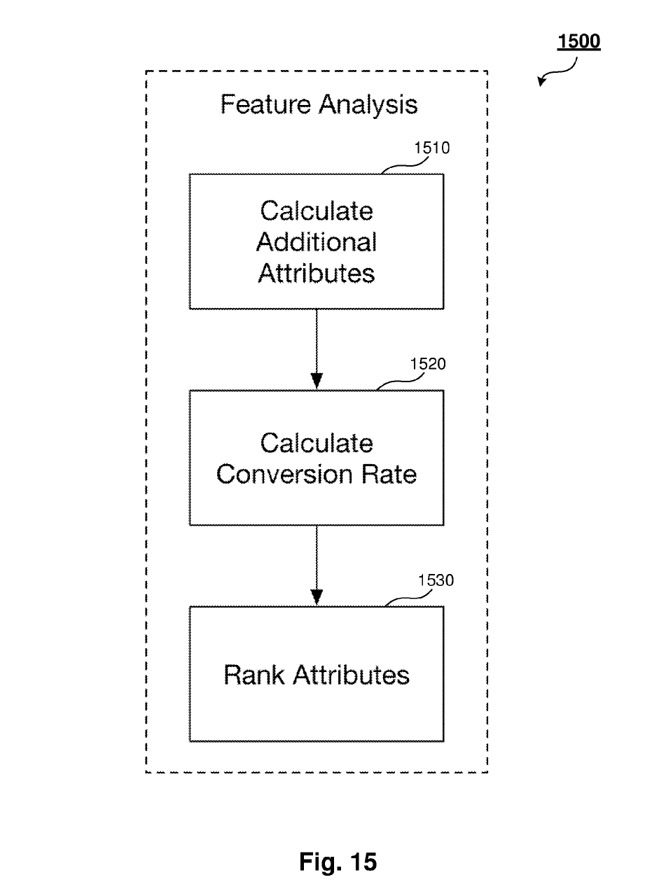

FIG. 9 illustrates a method 900 for processing data in the analytic engine 240. A first step 910 performs Feature Analysis across all of the available attributes about customers. FIG. 15 is a flow diagram 1500 illustrating the steps performed by the Feature Analysis stage of the analytic engine. Step 1510 involves calculating additional attributes for all customers, quotes and bookings, such as an activity metric. The activity metric is a sum of all the events that have been recorded for a particular customer. In one arrangement, different events are weighted as part of the activity metric calculation. Attributes are then analysed based the frequency of their values to determine additional attributes. For example, country of origin is the attribute and country Germany is the derived attribute. For each attribute and derived attribute, the conversion rate of bookings vs. quotes is calculated in step 1520. The number of bookings is calculated from the non-anonymous customers with transaction history and the quotes are made by the customers without transaction history as they have not made a purchase. Step 1530 ranks the attributes based on the conversion rate. In one arrangement, the conversion rate is ranked by ordering from highest to lowest.

Returning to FIG. 9, at this point, there are a number of cohorts or segments defined by a single attribute with an associated conversion rate of bookings and quotes. Each attribute defines a single cohort, but can also be combined with other attributes to create overlapping cohorts. Additional cohorts can also be applied by performing Cohort Analysis 920 on transaction history to determine cohorts based on business insights. Customers can belong to multiple cohorts, depending on their attributes and the defined cohorts.

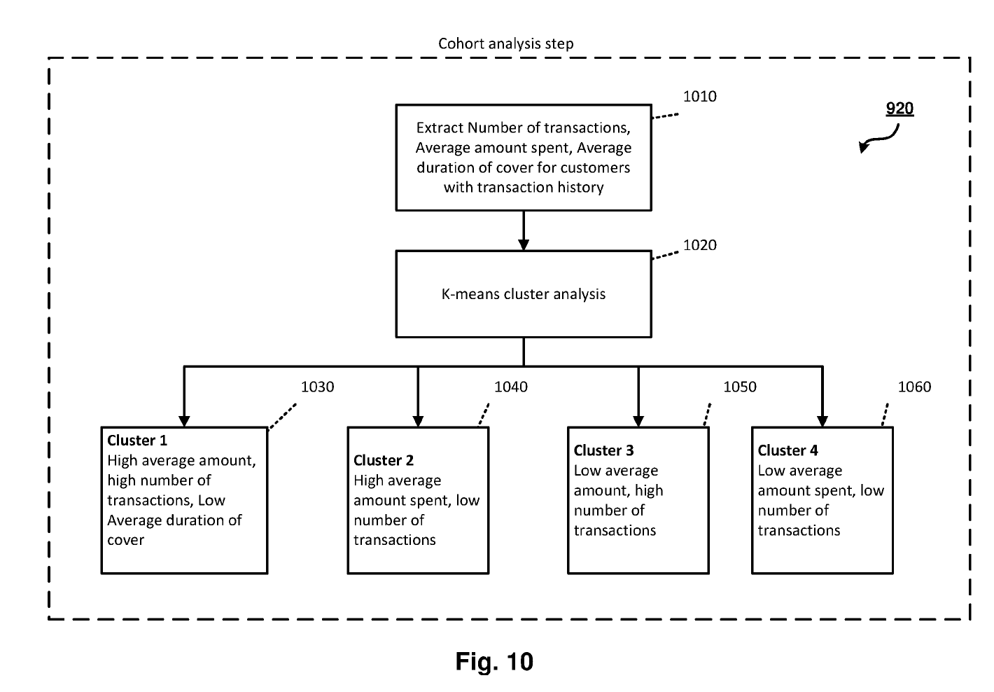

FIG. 10 illustrates an example of cohort analysis performed on a subset of the data: only on non-anonymous customers with transaction history. In a first step 1010, attributes are selected from the derived attributes as described in the Feature Analysis step. One implementation uses the following attributes:
Number of transactions;
Average amount spent; and
Average duration of cover.

Step 1020 applies k-means cluster analysis to obtain an optimal number of segments or cohorts. In the example of FIG. 10, the k-means cluster analysis generated four separate cohorts, characterised by:
High average amount, high number of transactions, low average duration of cover 1030;
High average amount spent, low number of transactions 1040;
Low average amount, high number of transactions 1050; and
Low average amount spent, low number of transactions 1060.

Each of these cohorts 1030, 1040, 1050, 1060 has a mathematically determined mean for the number of transactions, average amount spent, and average duration of cover. Each customer in the non-anonymous group with a purchase history belongs to one of the cohorts 1030, 1040, 1050, 1060, with each cohort having a distinct mean for the three noted parameters.

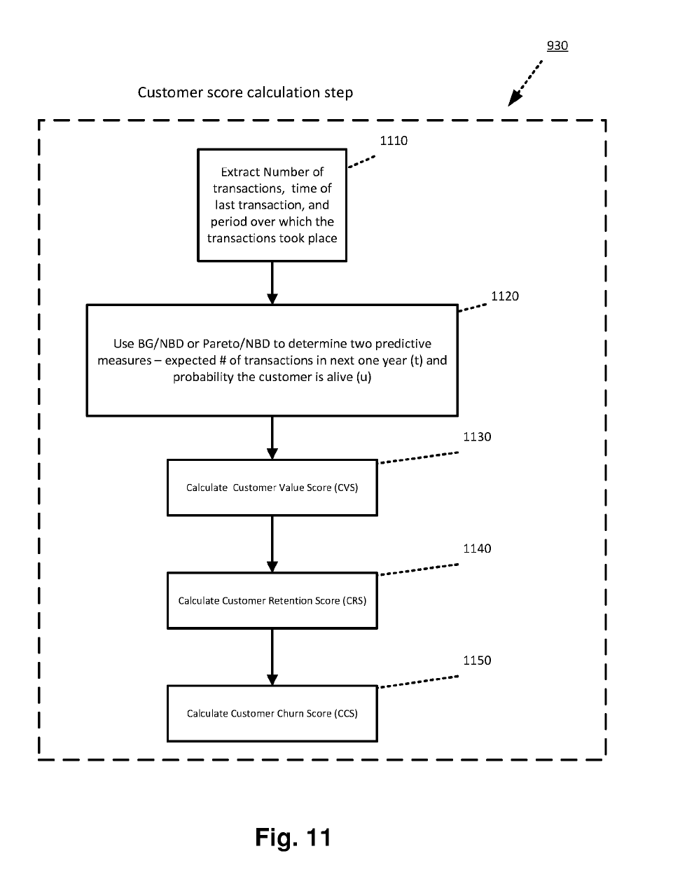

Additional attributes can be calculated for non-anonymous customers with transaction history. Returning to FIG. 9, step 930 determines customer scores for non-anonymous customers with a transaction or purchase history. FIG. 11 illustrates one implementation for the step 930, in which the following metrics are calculated for each customer in step 1110:
Number of transactions (frequency);
Time of last transaction; and
Total period over which the transactions took place.

The analytic engine 240 uses the metrics calculated in step 1110 to determine in step 1120 the following measures for each customer:
A predictive measure showing the number of transactions expected in the next one year (t); and
A probabilistic measure showing whether a customer is alive (u).

Depending on the implementation, step 1120 optionally uses a Beta Geometric/Negative Binomial Distribution (BG/NBD) or Pareto/Negative Binomial Distribution (Pareto/NBD) algorithm for Customer Lifetime Value to determine the two measures t and u.

Having determined the expected number of transactions t and whether the customer is alive u, the analytic engine 240 uses the two measures t and u to derive three scores for each customer:
Customer Value Score (CVS) 1130;
Customer Retention Score (CRS) 1140; and
Customer Churn Score (CCS) 1150.

To calculate the CVS 1130, the metric t, which predicts the number of transactions for each customer, is multiplied by the customer's average spend to get a predicted transaction value and the probabilistic measure u to get customer value, v. Thus, the CVS v is determined by:

v=t*u*(average historical spend per transaction)

The customer value v thus derived for each of the customers is then normalized by dividing the v by the maximum v. This then give a normalised value nv, which varies between 0 and 1. Multiplying the normalized value by 100 gives the CVS 1130, which is a score between 0 and 100.

nv=(v of the individual customer)/(max v among all customers for whom v has been calculated)

The average transaction value of each customer is normalized across all the customers and multiplied by 100 to derive a Customer Retention Score (CRS). This score varies between 0 and 100.

The probabilistic measure u is subtracted from 1 and then multiplied by 100 to obtain a score between 0 and 100. This score is a Customer Churn Score (CCS). A high CCS indicates a high chance that the customer has already defected or moved to a competitor.

At this stage of the process 900 of FIG. 9, all non-anonymous customers with a transaction history have CVS, CRS, and CCS scores. Further, all customers have derived attributes and associated rank, as calculated in step 910. To use these attributes for determining cohorts, a CVS, CRS and CCS score needs to be calculated for all non-anonymous and anonymous customers with no transaction history.

The next steps in the process 900 relate to calculation of CCS scores for non-anonymous and anonymous customers with no transaction history 940 and 950, respectively. A similar process is followed for all attributes that are derived from analysing the transaction history.

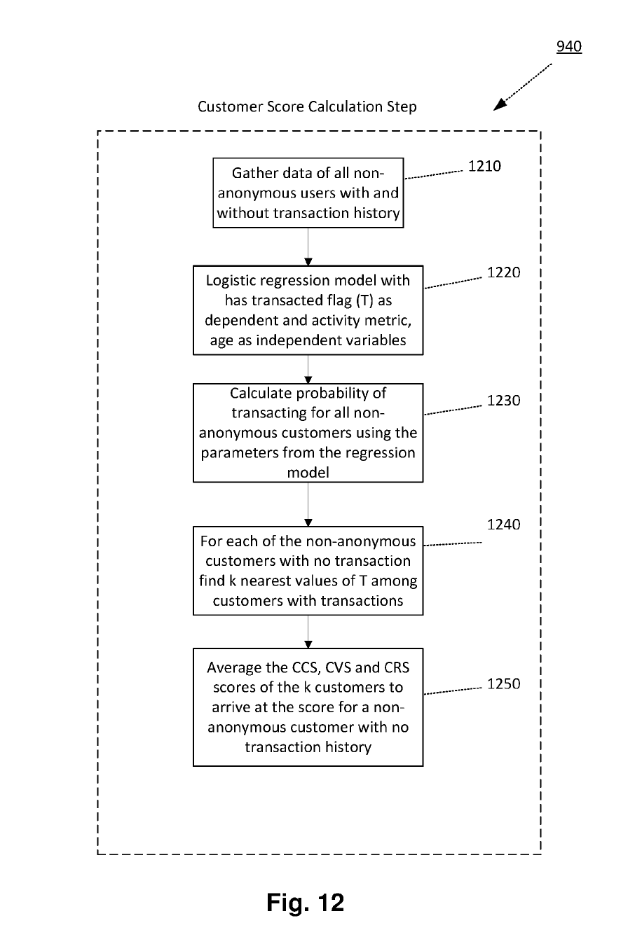

FIG. 12 illustrates the method of step 940, which begins with step 1210 gathering all data derived from non-anonymous users, irrespective of whether or not those users have a transaction history. In step 1220, the analytic engine 240 builds a logistic regression model with the dependent variable being T, where T is 0 if a customer has no transaction history and 1 if a customer has a transaction history. The dependent variables used are the activity metric and the age of each of the customers. The result of the logistic regression is three parameters α, β, c, where α is the coefficient for the activity metric, β is the coefficient for age, and c is a constant.

Step 1230 calculates probability of transaction for all non-anonymous customers using the parameters α, β, c produced by the regression model. For each non-anonymous user with no transaction history, c0, estimate T, using the logistic regression coefficients α, β, and c. Let the estimate of T be t0. Similarly, estimate T for all the customers who have transaction history. Let these estimates be t1, t2, . . . tn, where n is the number of customers.

Step 1240 uses the k-nearest neighbour method to find k nearest neighbours of t0 in t1 to tn. Step 1250 averages the CVS, CRS and CCS scores with the nearest estimates to produce the CVS, CRS and CCS scores for the customer c0.

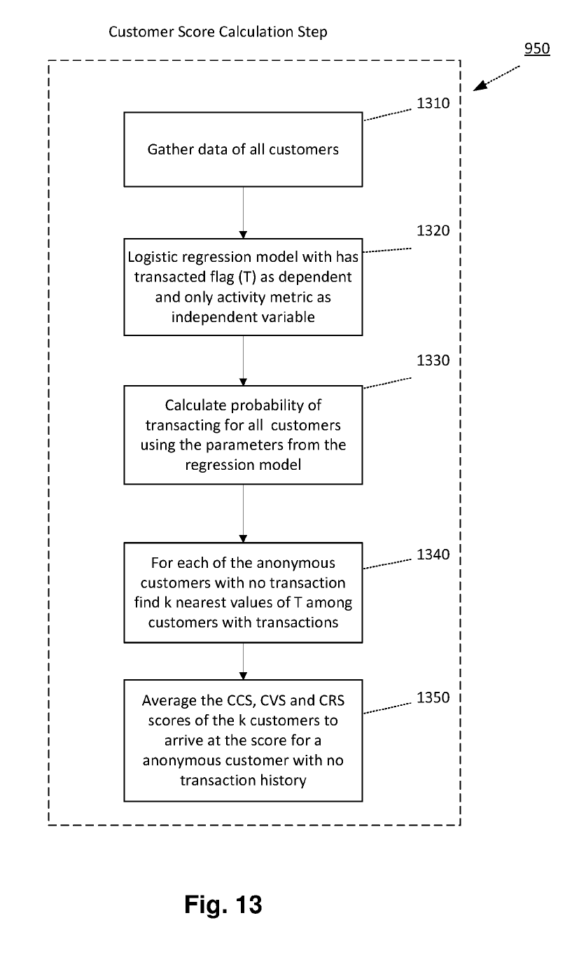

FIG. 13 illustrates the method 950, which begins with step 1310 gathering data records of all customers. To estimate the customer scores of the anonymous customer, step 1320 repeats the logistic regression process described with reference to step 1220 of FIG. 12, but using only the activity metric as the independent variable and using the customer set from 1310. Step 1330 determines the probability of transactions T for all customers using the logistic regression parameters produced in step 1320. Step 1340 finds, for each T calculated for an anonymous customer, k customers with transactions whose calculated T values are nearest to the T calculated for the anonymous customer 1340. Step 1350 averages the CVS, CRS and CCS scores of the k customers to arrive at the CVS, CRS, CCS scores of the anonymous customer. Customers are then ranked in order of their customer scores.

Returning to FIG. 9, at this stage of the process every customer is associated with derived attribute cohorts and cohorts through analysis of transaction history. Derived attributes have been ranked by the conversion rate of bookings vs quotes.

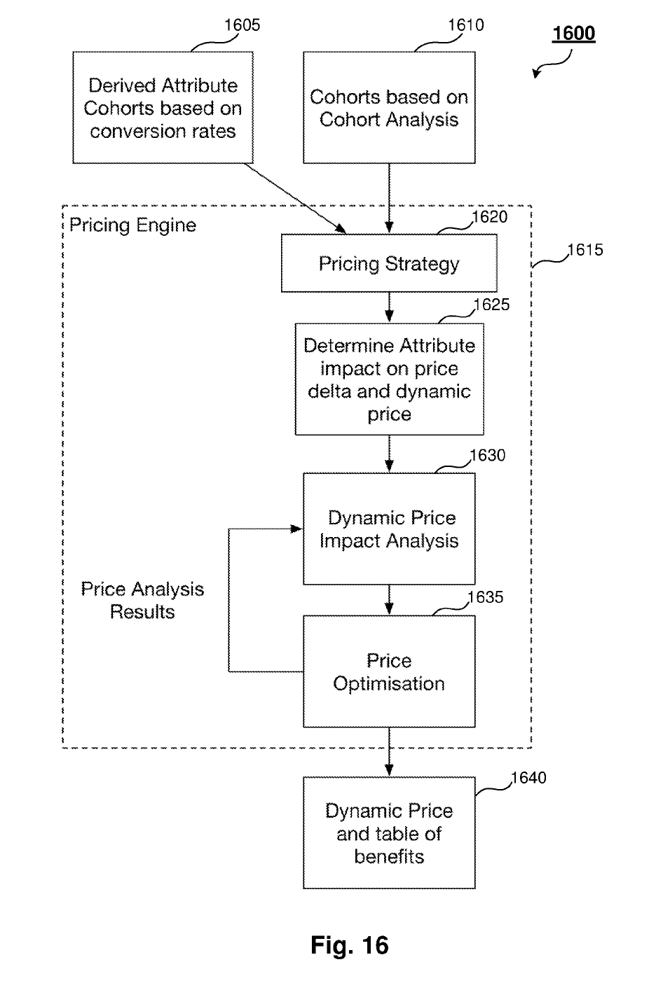

Next stage is to determine the price delta, which is the discount or increase to apply to the initial price. The Pricing Engine is responsible for determining the price delta to apply, the impact each attribute has on the price and for optimising the price. FIG. 16 is a flow diagram 1600 illustrating core steps involved in the Pricing Engine.

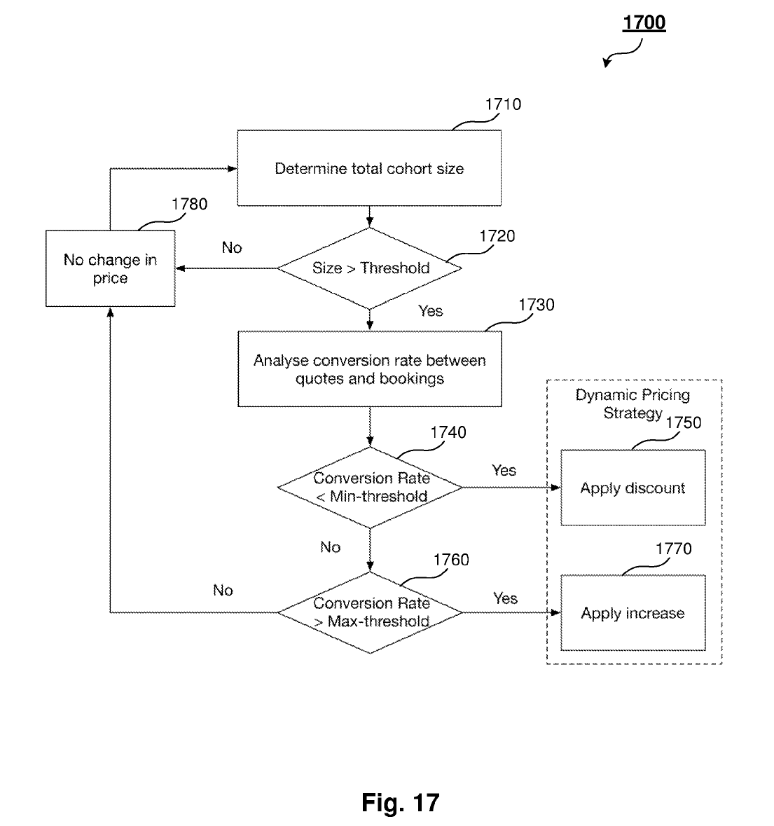

A pricing strategy, step 1620 of FIG. 16, must be applied to each type of cohort and is one of a discount, an increase, or no change. Thus, the pricing strategy step 1620 receives content from Derived Attribute Cohorts based on conversion rates 1605 and Cohorts based on Cohort Analysis 1610. FIG. 17 is a flow diagram 1700 illustrating the process for applying a pricing strategy to each cohort based on the attributes. A first step 1710 involves calculating the total size of the cohort, including the number of customers who made a quote or a booking. This value is passed to decision step 1720, which compares the total size of the cohort with a predefined threshold to determine if the cohort should have a dynamic pricing strategy applied. In one implementation, the threshold is 6500. If at step 1720 the total size of the cohort is not greater than the predefined threshold, No, then control passes from step 1720 to step 1780, which applies no change to the current price. However, if at step 1720 the total size of the cohort is greater than the predefined threshold, Yes, control passes from step 1720 to step 1730.

Step 1730 requires the conversion rate between quotes and bookings to be calculated for the cohort. Control then passes to step 1740, which compares the conversion rate against a predefined min-threshold to apply a discount. If the conversion rate is less than the min-threshold, Yes, then control passes to step 1750 to apply a discount. However, if at step 1740 the conversion rate is not less than the min-threshold, No, then control passes to step 1760, which compares the conversion rate against a max-threshold. If the conversion rate is greater than the max-threshold, Yes, control passes from step 1760 to step 1770, which applies an increase. If the conversion rate does not satisfy either of these conditions, and is thus not less than the min-threshold and not greater than the max-threshold, then control passes from step 1760 to step 1780, which applies no change to the price. Control passes from step 1780 to step 1710 In one implementation, the min-threshold is set at 4% and the max-threshold is set at 40%. It will be appreciated that other values of min-threshold and max-threshold may be used for different applications and implementations.

Returning to FIG. 16, control passes from the pricing strategy step 1620 to step 1625, which assigns a weight to each attribute to determine how the price will be influenced. At this stage, each attribute has a pricing strategy attached as either a discount, an increase, or no change. The attributes are split into those with a discount and those with an increase. Each group of attributes will be ordered based on the size of the cohort that is represented by that attribute. The attributes will then be scaled to a range from 0 to 1 to create the weights. These weights are used to determine pricing strategy when a customer is in multiple cohorts or segments.

To determine the dynamic price for a policy we begin by calculating an initial price. In step 1630 of FIG. 16, the Pricing Engine calculates a default price and standard table of benefits. The default price, or initial price, P is formulated as:

P=Claims Cost (CC)+Claims Processing Cost (CPC)+Over Heads (OH)+Margin (M)

In order to arrive at an initial price, the cost of claims is considered. This is done across all products and is done by comparing the total amount of claims settled by the total policies sold, which determines the cost attributed to a policy. Claims Processing Cost (CPC) is the total amount spent on processing claims divided by the number of policies sold. The same estimates are used with Over Heads (OH). Finally, a Margin (M) is added to arrive at the initial price (P). In this example, the Margin M is 25%.

The next step is to determine a default table of benefits for each cohort. One arrangement has standard templates stored for the schedule of benefits. A schedule of benefits may include, for example, items such as Excess Amount, Windscreen Cover Limit, Tyres Cover Limit, and Towing Cover Limit. Each of these items has an upper limit and a lower limit. Multiple schedules of benefits are created by using bands in between the upper and lower limits.

The pricing engine 250 assigns a schedule of benefits to each cohort. In this embodiment, the upper and lower limit are shown in Table 1:

TABLE 1

| Table Item | Upper Limit | Lower Limit |
|---|---|---|
| Excess Amount | 2000 | 0 |
| Windscreen Cover Limit | 2000 | 0 |
| Tyres Cover Limit | 2000 | 0 |
| Towing Cover Limit | 2000 | 0 |

The pricing engine 250 assigns each of the cohorts a value in between the upper and lower limit, thus associating a schedule of benefits for each cohort.

In one example the price delta is calculated based on cohorts defined by customer scores. The customer scores are averaged to determine an average score, which varies between 0 and 100. Depending on the score, the initial price is modified by the price delta, D. If the maximum price delta is D, then the amount of price delta is D for a customer with a score of 100 and 0 for a customer with a score of 0. This varies according to the formula:

(Avg Customer Score/100)*D.

A suitable value of D is chosen where D<=1−(1/(1+M)) where M is the margin chosen while setting the initial price. The value of D is chosen through an optimisation process.

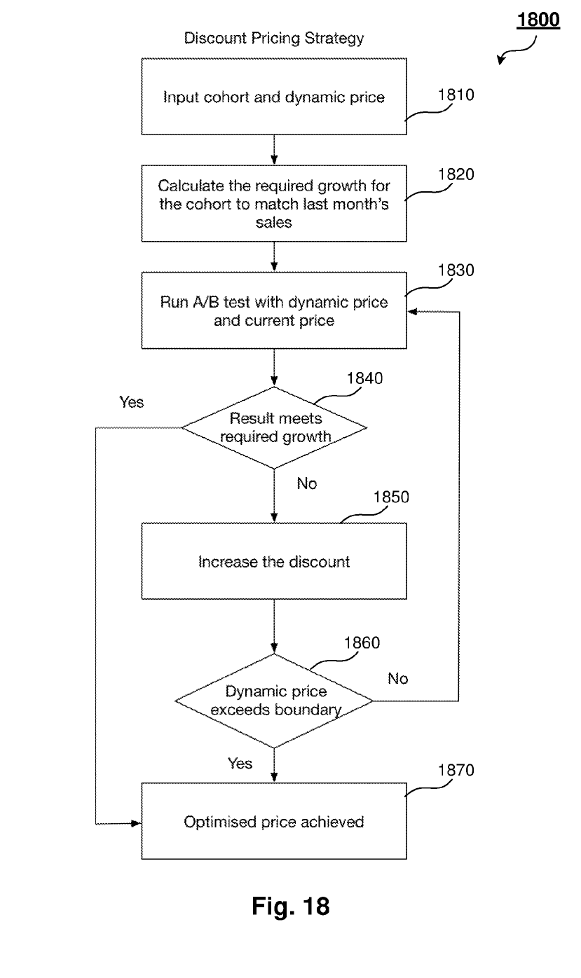

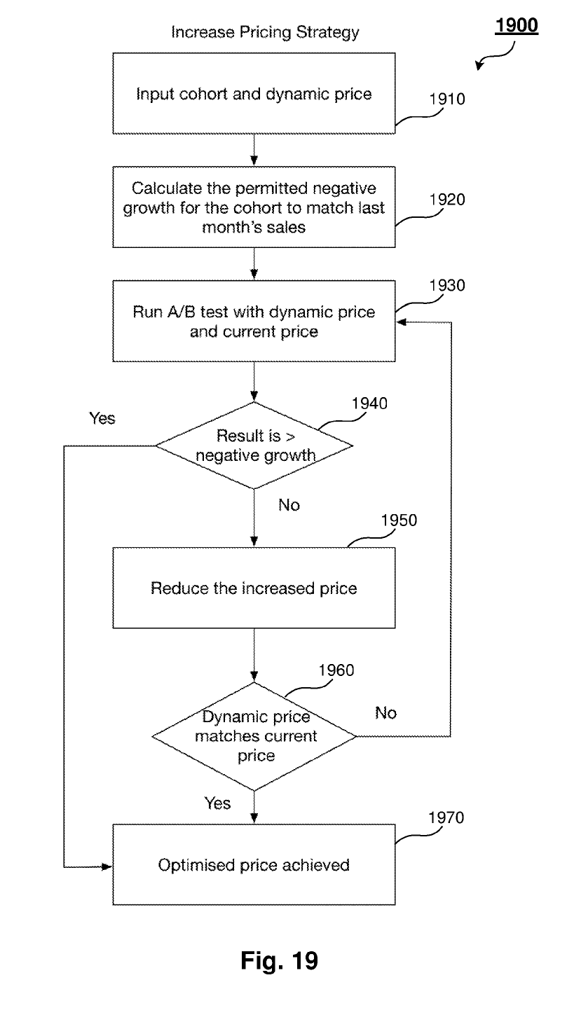

We now move to step 1635 in FIG. 16, which optimises the price delta applied for each cohort. The optimisations processes are shown in FIG. 18 for the discount pricing strategy and FIG. 19 for the increase pricing strategy. No optimisation step is required for cohorts that have been assigned a pricing strategy of no change.

FIG. 18 is a flow diagram 1800 illustrating a process of optimising the price for attributes that have been assigned a discount pricing strategy. All dynamic prices are determined prior to the user requesting a quote and stored on a disk for later retrieval. Step 1810 gathers the cohort size, conversion rate and the dynamically created price. Step 1820 then calculates the required cohort growth size to achieve a break even point assuming the same discount had been applied for the previous month.

Control then passes to Step 1830, which involves setting up an A/B Test where Test A uses the new dynamic price and Test B uses the default price. The A/B Test has a stop time and a required growth rate. At the conclusion of the experiment, the growth rate between Test A and Test B are compared. If at step 1840 the result is less than the required growth and thus the result does not meet the required growth, No, then the discount is stored and the discount increased by an amount. In one implementation, the increase is 2%. Step 1860 then determines whether the dynamic price exceeds a predefined boundary. If the dynamic price does not exceed the predefined boundary, No, control passes from step 1860 to step 1830. However, if the dynamic price does exceed the predefined boundary, Yes, control passes to step 1870. If at step 1840 the growth rate is exceeded, Yes, then control passes to step 1870 and the previously stored discount amount is the optimised price and is saved for the current cohort. In the case where no dynamic price is stored, the default price is assigned.

FIG. 19 is a flow diagram 1900 illustrating a process for optimising the increase pricing strategy. The process closely resembles that of the discount price optimisation, except the permitted negative growth for the previous month. Increasing the price negatively impacts customer's willingness to purchase a policy, so the growth impact determines the permitted number of lost customers to break even. Step 1910 gathers the cohort size, conversion rate and the dynamically created price. Step 1920 then calculates the permitted cohort negative growth size based on historical data to match the previous period's sales.

Control then passes to Step 1930, which involves setting up an A/B Test where Test A uses the new dynamic price and Test B uses the current price. The A/B Test has a stop time and a required growth rate. At the conclusion of the experiment, the growth rate between Test A and Test B are compared. If at step 1940 the result is not greater than the predefined negative growth, No, then step 1950 reduces the increased price. Step 1960 then determines whether the dynamic price matches the current price. If the dynamic price does not match the current price, No, control passes from step 1960 to step 1930. However, if the dynamic price does match the current price, Yes, control passes to step 1970. If at step 1940 the result is greater than negative growth, Yes, then control passes to step 1970 and the previously stored discount amount is the optimised price and is saved for the current cohort. In the case where no dynamic price is stored, the default price is assigned.

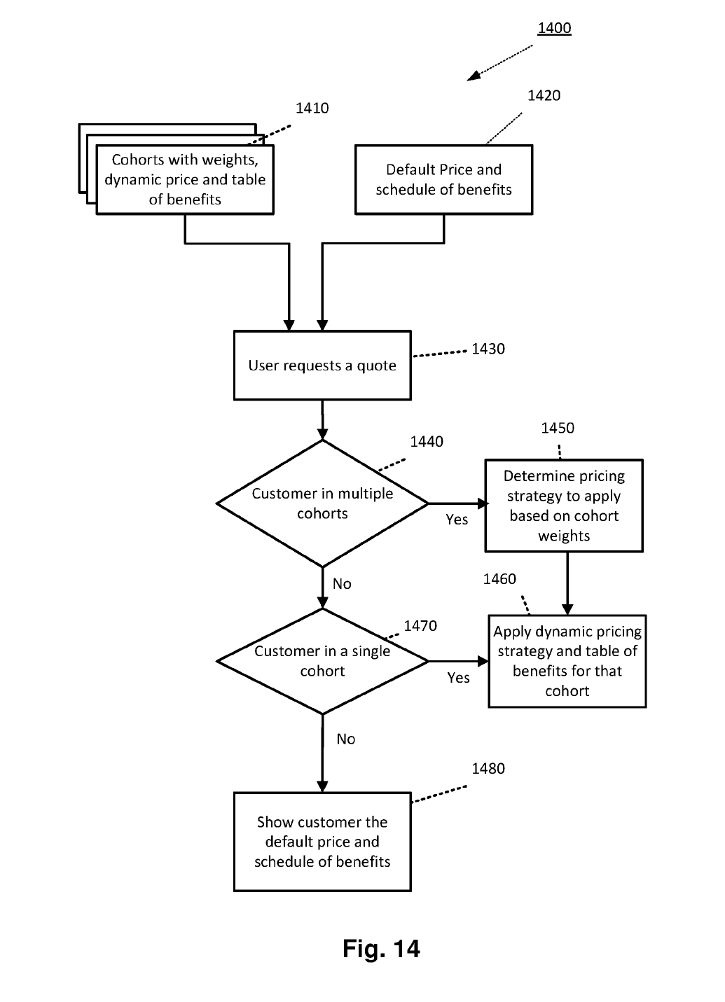

FIG. 14 illustrates a method 1400 for dynamically generating a price and schedule of benefits in relation to car rental insurance when a user makes a request for a quote, such as may be performed by the pricing engine 250 of FIG. 5. At this stage, there are cohorts with assigned pricing weights, dynamic prices and table of benefits 1410 and default price with default schedule of benefits 1420.

In step 1430, a customer requests a price for car rental cover. Decision step 1440 determines whether the customer falls into multiple cohorts or segments. If No, control passes from step 1440 to another decision step, 1470. If, Yes, flow moves to step 1450, where the weights for all of the cohorts that the customer is in are added, with all of the discount weights added together and all of the increase cohort weights added separately. The pricing strategy with the largest value is the strategy that gets applied. Flow then moves to step 1460, where a dynamic price and table of benefits are shown to the user.

Back at the decision step 1470, which determines if a customer is in a single cohort. If the customer is in a single cohort, Yes, a dynamic price and table of benefits are shown to the user at step 1460. If, No, the user is shown the default price and table of benefits for that cohort shown at step 1480.

In jurisdictions or applications that prevent or do not implement dynamic pricing of products, each cohort is assigned a separate product. The same pricing process will be applied except the product for each cohort will be updated during the optimisation step. The pricing engine will then be responsible for selecting the appropriate priced product that matches the cohort, instead of updating the price of a single product.

### INDUSTRIAL APPLICABILITY

The arrangements described are applicable to the information technology and insurance industries and particularly for the travel insurance and car rental industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A method for delivering a tailored product to a user, comprising the steps of:
capturing data relating to at least one of an interaction or transaction by said user in relation to a website, the data including metadata relating to at least one of the interaction or the transaction;
storing said captured data in a storage device;
generating a set of customer attributes for said user, based on said captured data;
receiving a request for a quotation from said user; and
delivering a product to said user in response to said request, said product being tailored based on said set of customer attributes.

2. The method according to claim 1, further comprising the step of:
generating a set of scores, derived from said customer attributes;
wherein said product is tailored based on said set of scores.

3. The method according to claim 2,
wherein said set of scores includes a customer value score, a customer retention score and a customer churn score, and
further wherein said product includes a price, said price being based on based on at least one of said customer value score, said customer retention score, and said customer churn score.

4. The method according to claim 3, wherein said user is a non-anonymous user with a transaction history, said method comprising the further step of:
applying one of a Beta Geometric/Negative Binomial Distribution (BG/NBD) or Pareto/Negative Binomial Distribution (Pareto/NBD) algorithm to determine parameters relating to an expected number of transactions and whether the customer is alive; and
deriving said customer value score, said customer retention score, and said customer churn score from said parameters.

5. The method according to claim 3, wherein said user is an anonymous or non-anonymous user without a transaction history, said method comprising the further step of:
applying a logistic regression, using an activity metric as an independent variable, to determine said customer value score, said customer retention score, and said customer churn score.

6. The method according to claim 1, said method comprising the further step of:
determining a schedule of benefits based on cohort analysis of said captured data, said schedule of benefits forming at least part of said product.

7. (canceled)

8. The method according to claim 1, wherein capturing said data is performed by embedded code executing within a web browser.

9. The method according to claim 8, wherein said embedded code is a JavaScript program.

10. The method according to claim 1, wherein capturing said data is performed by a request within a web page.

11. A system for delivering a tailored product to a user, said system comprising:
a server coupled to a communications network, said server including:
a memory for storing data and a computer program;
a processor coupled to said memory for executing said computer program stored in said memory;
a tailoring application forming part of said computer program, said tailoring application including instructions for performing steps of:
capturing data relating to at least one of an interaction or transaction by said user in relation to a website, the data including metadata relating to at least one of the interaction or the transaction;
storing said captured data in said memory;
generating a set of customer attributes for said user, based on said captured data;
receiving a request for a quotation from a computing device accessed by said user, said computing device being coupled to said communications network; and
delivering a product to said user in response to said request, said product being tailored based on said set of customer attributes.

12. The system according to claim 11, wherein said tailoring application further includes instructions for performing a step of:
generating a set of customer scores, derived from said customer attributes;
wherein said product is tailored based on said customer scores.

13. The system according to claim 12,
wherein said set of scores includes a customer value score, a customer retention score and a customer churn score, and
further wherein said product includes a price, said price being based on based on at least one of said customer value score, said customer retention score, and said customer churn score.

14. The system according to claim 13, wherein said user is a non-anonymous user with a transaction history, wherein said tailoring application includes instructions for performing further steps of:
applying one of a Beta Geometric/Negative Binomial Distribution (BG/NBD) or Pareto/Negative Binomial Distribution (Pareto/NBD) algorithm to determine parameters relating to an expected number of transactions and whether the customer is alive; and
deriving said customer value score, said customer retention score, and said customer churn score from said parameters.

15. The system according to claim 13, wherein said user is an anonymous or non-anonymous user without a transaction history, said tailoring application including instructions for performing further steps of:
applying a logistic regression, using an activity metric as an independent variable, to determine said customer value score, said customer retention score, and said customer churn score.

16. The system according to claim 11, wherein said tailoring application includes instructions for performing further steps of:
determining a schedule of benefits based on cohort analysis of said captured data, said schedule of benefits forming at least part of said product.

17. (canceled)

18. The system according to claim 11, wherein capturing said data is performed by embedded code executing within a web browser.

19. The system according to claim 18, wherein said embedded code is a JavaScript program.

20. The system according to claim 11, wherein capturing said data is performed by a request within a web page.

21. A computer readable storage medium having recorded thereon a computer program for delivering a tailored product to a user, said computer program comprising code for performing the steps of:
capturing data relating to at least one of an interaction or transaction by said user in relation to a website, the data including metadata relating to at least one of the interaction or the transaction;
storing said captured data in a storage device;
generating a set of customer attributes for said customer, based on said captured data;
receiving a request for a quotation from said user; and
delivering a product to said user in response to said request, said product being tailored based on said set of customer attributes.

22. The computer readable storage medium of claim 21, wherein said computer program comprises further code for performing the step of:
generating customer scores derived from said customer attributes;
wherein said product is tailored based on said set of customer scores.
